(19) United States
(12) Patent Application Publication
(10) Pub. No.: US 2014/0095290 A1
(43) Pub. Date: Apr. 3, 2014

(54) SAVINGS-GUARANTEE APPARATUS AND METHOD

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/630,892

(22) Filed: Sep. 28, 2012

(51) Int. Cl. G06Q 30/02; G06Q 30/00; G06Q 30/06

(52) U.S. Cl. 705/14.34; 705/39; 705/1.1

(57) ABSTRACT

A method for comparing pricing of selected products over a certain period of time is disclosed. The method may begin with completing, by a computer system, a plurality of transactions between a first business and a particular customer. The plurality of transactions may comprise the purchase, by the particular customer, of a plurality of goods from the first business. The method may further including recording, by the computer system, an actual cost charged the particular customer for the plurality of goods. The computer system may also calculate a first hypothetical cost reflecting what the particular customer would have been charged for the plurality of goods had the plurality of goods been purchased from a second business. Accordingly, the computer system may generate a comparison between the actual cost and the first hypothetical cost and present the comparison to the particular customer.

### BACKGROUND

1. Field of the Invention

This invention relates to promotional programs and more particularly to systems and methods for leveraging receipt data to guarantee savings to a particular customer.

2. Background of the Invention

Many point-of-sale (POS) and back office systems currently in use today do not support important emerging technologies, services, and marketing opportunities. For example, many POS and back office systems are limited in their ability to leverage the electronic receipt data they collect. Accordingly, what is needed is an apparatus and method expanding the ability of a wide variety of POS and back office systems, include legacy systems, to make improved use of the receipt data they collect.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of one embodiment of a point-of-sale (POS) system for implement methods in accordance with the present invention;

FIG. 2 is a schematic block diagram of one embodiment of multiple POS systems in accordance with the present invention operating in the context of an enterprise-wide system;

FIG. 3 is a schematic block diagram of one embodiment of a receipt in accordance with the present invention;

FIG. 4 is a schematic block diagram of one embodiment of a receipt module in accordance with the present invention;

FIG. 5 is a schematic block diagram of one embodiment of a promotional program in accordance with the present invention;

FIG. 6 is a schematic block diagram of one embodiment of a guarantee module in accordance with the present invention; and

FIG. 7 is a block diagram of one embodiment of a method for executing a promotional guarantee in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for leveraging receipt data collected at a POS. For example, in selected embodiments, one method in accordance with the present invention may begin when an application is issued and/or installed on a computing device of a customer. The application may be programmed to enable a customer to participate in one or more promotional programs.

Within the method, an entity may issue a guarantee and enroll one or more customers therein. The entity may then conduct one or more purchase transaction with each of the enrolled customers. The prices being charged for certain items may be read and recorded. Using competitor pricing data, a comparison may be made between the amount charged by the entity and one or more hypothetical amounts that would have been charged by one or more competitors of the entity. This difference in pricing may be recorded and, in selected embodiments, presented to the corresponding customer.

Eventually, an end of a time period associated with a guarantee may be reached. At that time, if the total amount charged by the entity is less than the amount that would have been charged by any competitor, then nothing is owed to the corresponding customer. Conversely, if the total amount charged by the entity is not less than the amount that would have been charged by a competitor, then compensation in accordance with the details of the guarantee may be made.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

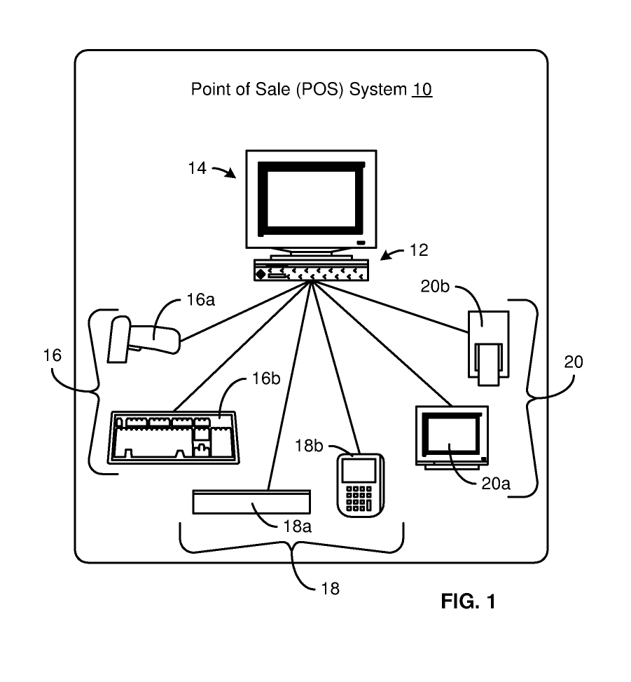

Referring to FIG. 1, in selected embodiments, the hardware, software, or hardware and software of a POS system 10 may be configured to implement one or more methods in accordance with the present invention. For example, a POS system 10 may be manufactured, programmed, modified, or upgraded to support collection of receipt data that can be used in a promotional guarantee.

A POS system 10 in accordance with the present invention may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 in accordance with the present invention may include an accounting interface to pass certain information to one or more in-house or independent accounting applications.

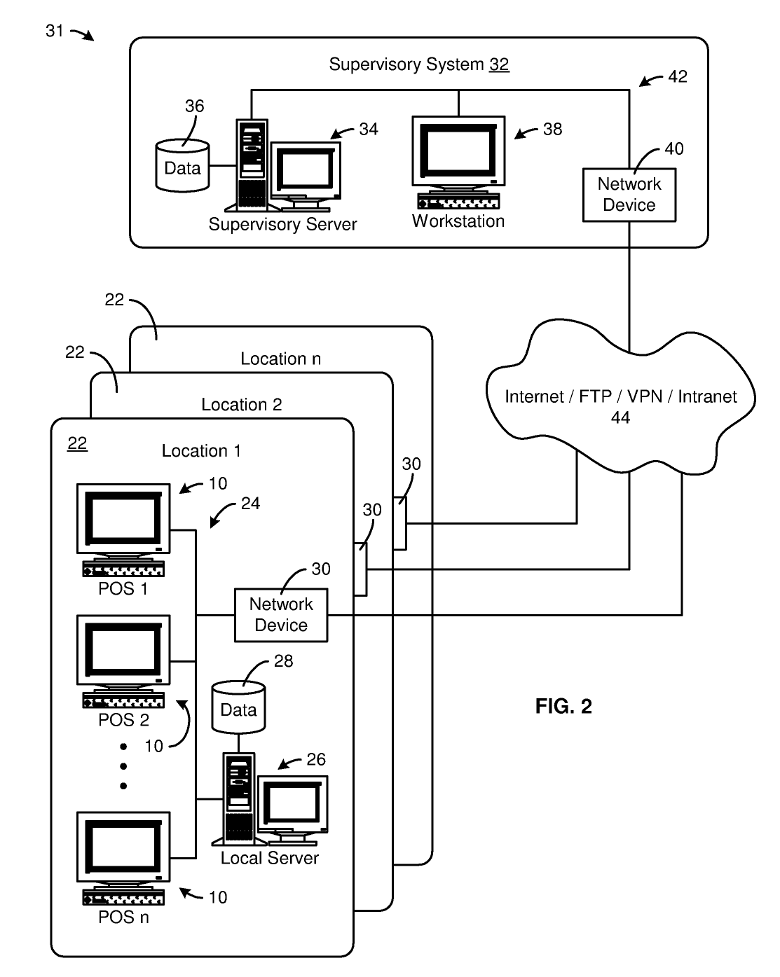

Referring to FIG. 2, in selected embodiments, a POS system 10 may operate substantially independently, as a stand-alone unit. Alternately, a POS system 10 in accordance with the present invention may be one of several POS systems 10 forming the front line of a larger system. For example, multiple POS systems 10 may operate at a particular location 22 (e.g., within a retail, brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 in accordance with the present invention may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more supervisory servers 34 providing a central repository from which certain data needed by the one or more POS systems 10 or local servers 26 may be stored, indexed, accessed, or the like.

Alternatively, or in addition thereto, a supervisory server 34 may receive and compile (e.g., within one or more associated databases 36) data from the various associated POS systems 10 or local servers 26 to provide or support inventory control, purchasing, receiving and transferring products, or the like. A supervisory server 34 may also receive and compile sales and customer information for reporting purposes, marketing purposes, receivables management, trend analysis, cost analysis, price analysis, profit analysis, or the like.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

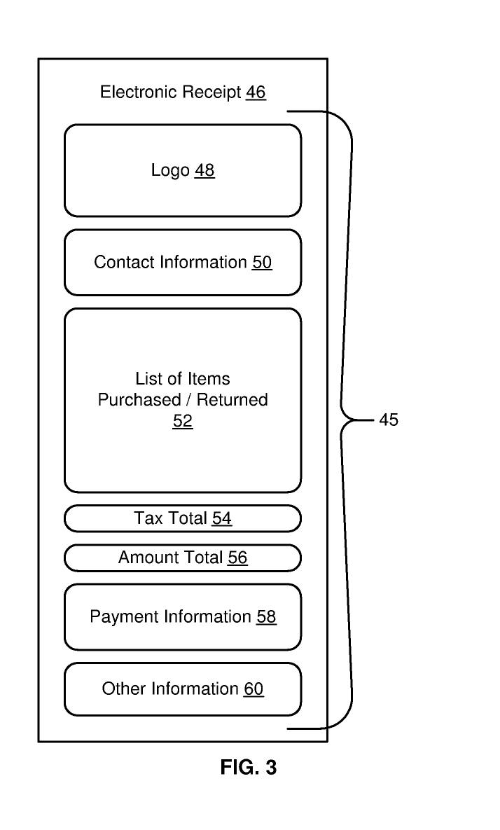

Referring to FIG. 3, a POS system 10 may collect and/or generate receipt data 45. Receipt data 45 may document a transaction (e.g., sale or return) carried out by a POS system 10. Receipt data 45 may be presented or displayed to a customer in the form of an electronic (e.g., paperless) receipt 46. In selected embodiments, receipt data 45 may be delivered to a customer's computing device (e.g., a mobile telephone, personal digital assistant (PDA), media player, tablet computer or reader, laptop computer, desktop computer, or the like, hereinafter a “computing device”) by an entity's computer system (e.g., a system comprising one or more POS systems 10, local servers 26, supervisory servers 34, some other onsite resources, some other offsite resources, or the like or combinations or sub-combinations thereof, hereinafter a “computer system”).

In selected embodiments, receipt data 45 and an electronic receipt 46 may include a logo 48, contact information 50, a list 52 of items purchased or returned, a total 54 indicating the sales tax assessed or returned, a total 56 indicating the amount paid or returned, payment information 58, other information 60, or the like or combinations or sub-combinations thereof.

A logo 48 may reinforce the brand and image of the associated entity within the mind of a consumer. By including contact information 50 on an electronic receipt 46, an entity may ensure that a customer has ready access to one or more physical addresses, Internet address, telephone numbers, facsimile numbers, hours of operation, or the like or combinations or sub-combinations thereof. One or more of a list 52 of items purchased or returned, a total 54 indicating the sales tax assessed or returned, a total 56 indicating 56 the amount paid or returned, and payment information 58 (e.g., date of transaction, an indication of method of payment, an indication of which credit or debit card was used, etc.) may be included to document important details of a transaction.

Other information 60 may be included within an electronic receipt 46 as desired or necessary. For example, to promote brand loyalty, an entity may include an indication of an amount saved in the transaction, a yearly total of the amount saved, reward points earned, or the like. Alternatively, or in addition thereto, other information 60 may include promotional information, a solicitation to participate in a survey, an employment opportunity, contest information, or the like.

An electronic receipt 46 may be presented by a computing device of a customer in any suitable layout or format. For example, the receipt data 45 forming an electronic receipt 46 may simply be presented as a textual list. Alternatively, an electronic receipt 46 may follow the form of a paper receipt. That is, the electronic receipt 46 may comprise a virtual representation or layout substantially matching what a comparable paper receipt would look like.

The manner in which an electronic receipt 46 is presented or displayed on a computing device of a customer may be completely dictated by the computer system delivering the receipt data 45 thereto. Alternatively, the computing device of the customer may have an application (e.g., a receipt manager, accounting program, budgeting program, or the like) installed thereon. Such an application may partially or completely control the layout or format of an electronic receipt 46 displayed therewith or therethrough. For example, a computer system may supply receipt data 45, while the application installed on the computing device of the customer supplies the layout or formatting.

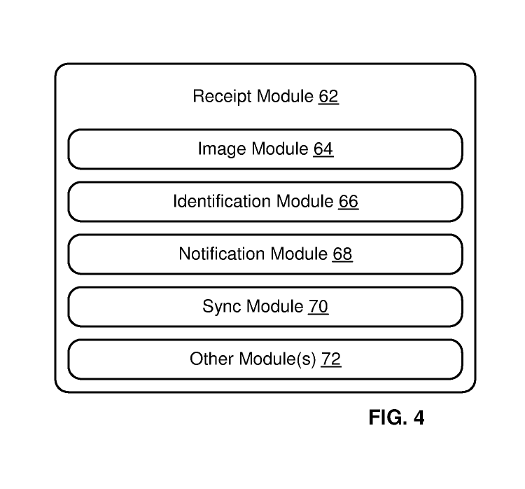

Referring to FIG. 4, a computer system in accordance with the present invention may deliver receipt data 45 to a computing device of a customer in any suitable manner. In selected embodiments, a receipt module 62 may enable or support such delivery. A receipt module 62 may include any suitable arrangement of sub-components or modules. In certain embodiments, a receipt module 62 may include an image module 64, identification module 66, notification module 68, synchronization module 70, one or more other modules 72 as desired or necessary, or the like or some combination or sub-combination thereof.

An image module 64 may assemble, generate, or obtain an advertisement containing a call to action for display on a receipt (e.g., paper receipt), customer-facing display 20a, or the like. In selected embodiments, a call to action may invite or motive a consumer to download receipt data 45. To increase the likelihood that a consumer will respond favorably to the call to action, an advertisement may include an enabler facilitating the desired step or action. For example, in selected embodiments, an advertisement may include a machine-readable code. By scanning the code (e.g., scanning the code using a camera on a mobile telephone, tablet computer, or the like), a consumer may import receipt data 45 encoded within the code. Alternatively, scanning the code may initiate the download of receipt data 45.

For example, a machine-readable code may be encoded with a URL. In addition to designating a particular resource, a URL may also include a transaction identification (ID). Accordingly, after an appropriate application is launched and a machine-readable code is scanned, a URL may be passed from a customer (e.g., from a mobile telephone of a customer) to an Internet Service Provider (e.g., a telecommunications provider). As a result, an appropriate resource within a computer system may be accessed and receipt data may be returned to (e.g., downloaded by) a computing device.

In selected embodiments, a machine-readable code may comprise a barcode. For example, in certain embodiments, a machine-readable code may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode for use in accordance with the present invention may follow any suitable protocol, format, or system. In selected embodiments, a two-dimensional code may be embodied as a Quick Response (QR) Code.

An identification module 66 may be tasked with requesting, collecting, and/or communicating identification information linking a customer associated with a transaction with one or more records stored within a computer system. For example, as part of a transaction carried out at a POS system 10, an identification module 66 may request, collect, and/or communicate identification information linking a transaction to a particular computing device corresponding to the customer participating in the transaction. Thus, information corresponding to the transaction may be passed to the customer via the particular computing device.

An identification module 66 may request, collect, and/or communicate one or more types of identification information. For example, in selected embodiments, an identification module 66 may collect a unique identification or membership number from a customer. This may be done when a membership card, club card, loyalty card, identification card, credit card, debit card, fingerprint or other biometric characteristic, or the like is scanned, input, or otherwise collected at a POS system 10. In other situations, a cashier or customer may type in a unique identification number, payment number, membership number, or the like at a POS system 10. For example, while a cashier is processing a transaction, a customer may be prompted via a card reader 18b, customer-facing display 20, or the like to enter (e.g., type in using the card reader 18b) a mobile telephone number corresponding to the customer. Alternatively, a cashier may type in a telephone number corresponding to the customer.

Once the identification information is received, it may be used directly (e.g., used directly to pass receipt data 45 to a computing device of a corresponding customer). Alternatively, or in addition thereto, the identification information may be linked to one or more previously stored computer records. Within such records, a computer system may find the information necessary to identify and communicate with a computing device of a corresponding customer.

A notification module 68 may assemble, generate, obtain, direct, and/or issue one or more push notifications. In selected embodiments, push notifications may be directed to a computing device of a customer. For example, when an appropriate application in not running on a computing device, push notifications may inform the customer that certain data or options are available (e.g., that a new electronic receipt 46 is available for download).

A synchronization module 70 may support or enable one way or two way data communication between a computer system and a computing device. For example, a synchronization module 70 may support or enable the passing of receipt data 45 from a computer system to a computing device. A synchronization module 70 may also enable certain data received from a computing device to be incorporated within or used by a computer system. For example, one or more user preferences (e.g., notification preferences) may be communicated to a computer system from an application resident on a computing device.

The various functions or modules of a receipt module 62 may be enacted or implemented by any suitable system or component thereof. For example, in selected embodiments, one or more functions or modules of a receipt module 62 may be distributed across one or more hardware devices, including a primary computer 12 of a POS system 10, a local server 26, a supervisory server 34, some other onsite resource, some other offsite resource, or the like or combinations or sub-combinations thereof. Thus, systems and methods in accordance with the present invention may be adapted to a wide variety of situations, including more rigid legacy systems.

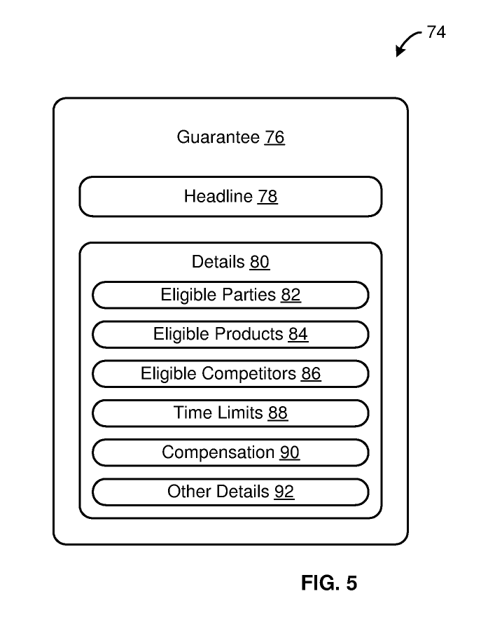

Referring to FIG. 5, in selected embodiments, a computer system, computing device, or some combination thereof may support or enable one or more promotional programs 74. A promotional program 74 may be implemented to increase revenue, strengthen a brand, build customer loyalty, or the like. The exact nature, conditions, rules, or the like of a promotional program 74 may vary between embodiments. In certain embodiments, a promotional program 74 may comprise a guarantee 76.

In selected embodiments, a guarantee 76 may include a headline 78 functioning as a title, call to action, “public face” of the guarantee, or the like. A headline 78 may comprise a short introduction to a guarantee 76. A headline 78 may also invite or motivate a customer to participate in a guarantee 76. For example, a headline 78 may state “If you shop with us, we guarantee you'll save money,” “Experience Guaranteed Savings,” or the like.

A guarantee 76 may be fleshed out by various details 80. Such details 80 may provide the substance behind or supporting a headline 78. The exact nature of the details 80 may vary with the particular guarantee 76 at issue. For example, in selected embodiments, a guarantee 76 may promise that a customer will come out ahead (e.g., save money) should the customer do business with a primary entity rather than with one or more competitors of the primary entity. The details 80 corresponding to such a guarantee 76 may define the eligible parties 82 (e.g., the entities from whom and to whom the guarantee 76 is extended), the eligible products 84 (e.g., the products or types of products that are to be used in calculating price comparisons), the eligible competitors 86 (e.g., the type of businesses that will be viewed as competitors, the geographical limit or proximity radius used in identifying competitors, or the like), the time limits 88 (e.g., the period of time over which the comparison between the primary entity and the one or more competitors will extend), the compensation 90 (e.g., the benefit to be conferred on a customer should the primary entity actually cost the customer more), other details 92, or the like or some combination or sub-combination thereof.

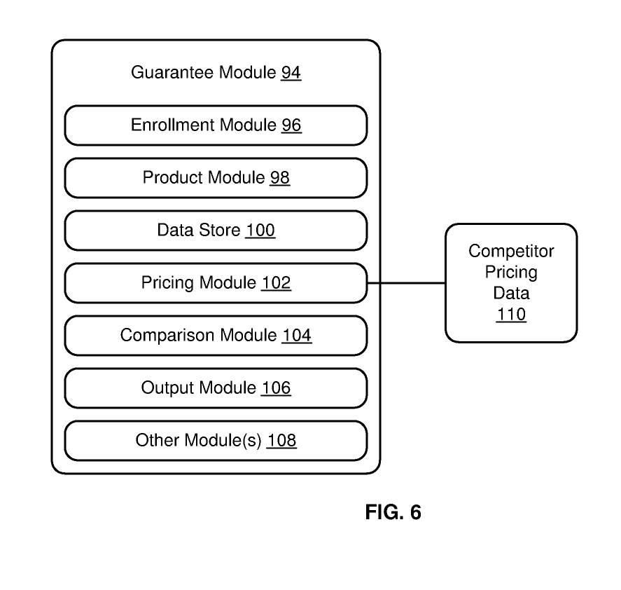

Referring to FIG. 6, in certain embodiments, a promotional program 74 may require monitoring of (or calculations based on) data collected by or passing within a computer system, computing device, or the like. Accordingly, a computer system, computing device, or some combination thereof may support one or more modules providing functionality related to one or more promotional programs 74.

For example, a computer system, computing device, or some combination thereof may support a guarantee module 94. A guarantee module 94 may enable an entity to make a guarantee 76 and monitor and/or report certain conditions or calculations underlying or corresponding to the guarantee 76. A guarantee module 94 may include any suitable arrangement of sub-components or modules. In certain embodiments, a guarantee module 94 may include an enrollment module 96, product module 98, storage module 100, pricing module 102, comparison module 104, output module 106, one or more other modules 108 as desired or necessary, or the like or some combination or sub-combination thereof.

An enrollment module 96 may support or enable the participation of one or more customers in a guarantee 76. In selected embodiments, an enrollment module 96 may control or support certain marketing efforts to increase the number of customers aware of a guarantee 76. Alternatively, or in addition thereto, an enrollment module 96 may enable one or more customers to join a guarantee 76. This may include communicating the specifics (e.g., details 80) of a guarantee 76, recording the identities of customers who have joined a guarantee 76, insuring that the customers who are joining a guarantee 76 have certain tools (e.g., software, applications, etc.) associated with or required by the guarantee 76. For example, in selected embodiments, an enrollment module 96 may automatically enroll a particular customer in a guarantee 76 when the customer downloads and installs an electronic receipt application on a computing device.

A product module 98 may enable a guarantee module 94 to control which products correspond to a particular guarantee 76. For example, in selected embodiments, an entity may issue a guarantee 76 promising that, over a certain period of time (e.g., one month, six months, or the like), a primary entity will charge less for selected products that any competitor located within a selected distance of the primary entity. In such embodiments, a product module 98 may identify the products forming part of the guarantee 76 and identify certain equivalencies therebetween.

For example, in certain embodiments, a guarantee 76 may relate to all grocery items. Alternatively, a guarantee 76 may relate only to certain common grocery items like milk, bread, eggs, and the like. In either case, a product module 98 may identify specific products. Certain such products may correspond to ubiquitous brand names and be directly comparable between different retailers. For example, a 15.6 ounce box of WHEATIES cereal sold by a primary entity may be directly comparable to a 15.6 ounce box of WHEATIES cereal sold by any competitor of the primary entity. Other such products may correspond to house brands. Accordingly, in selected embodiments, a products module 98 may equate a house-branded product offered by a first retailer to a house-branded product of one or more competitors of the primary entity.

A data store 100 may record selected data relevant to each customer enrolled in a guarantee 76. For example, a data store 100 may receive receipt data 45 and record what a particular customer was charged by a primary entity during one or more transactions for one or more (e.g., all) eligible products 84 contained therewithin.

A pricing module 102 may assist in determining what a customer would have paid for certain items had the customer purchased the items from one or more competitors of the primary entity. In selected embodiments, to perform its function, a pricing module 102 may access or receive certain competitor pricing data 110. Such data may identify what various competitors were charging for an array of products on a particular date.

Competitor pricing data 110 may be collected by any suitable entity. In selected embodiments, the data 110 may be collected by a third party, independent of the primary entity and any of its competitors. Accordingly, the data 110 may both appear to be and actually be accurate and unbiased. Competitor pricing data 110 may be collected in any suitable manner. Suitable methods for collecting such data 110 may include in-store visits, scanning pricing data printed in periodic (e.g., weekly) circulars, accessing information possessed or collected by certain regulatory bodies, crowd sourcing, scanning receipts, or the like or some combination or sub-combination thereof.

Competitor pricing data 110 may be geographically and/or temporally specific. Accordingly, a pricing module 102 may determine what a customer would have paid for specific items had the customer purchased the items from specific stores on specific dates. Geographic limitations may be specified in any suitable manner. For example, a proximity radius of anywhere in the range of one to twenty miles from a primary entity may be used or useful. Accordingly, only pricing data of competitors within the proximity radius may be taken into account. Temporal limitations may also be specified in any suitable manner. In selected embodiments, a proximity window of anywhere in the range of one to ten days may be used or useful. Accordingly, only pricing data of competitors within the proximity window may be taken into account. Once such hypothetical charges have been determined, they may be appropriately recorded within a data store 100.

Using data contained within a data store 100, a comparison module 104 may mathematically compare one or more amounts charged by a primary entity and one or more hypothetical amounts that would have been charged by one or more competitors of the primary entity. For example, a comparison module 104 may calculate a monetary difference between one or more amounts charged by a primary entity and one or more hypothetical amounts that would have been charged by one or more competitors of the primary entity.

An output module 106 may output certain data to a primary entity, customer, or the like. For example, an output module 106 may present a monetary difference calculated by a comparison module to a primary entity, corresponding customer, or some combination thereof. Accordingly, the primary entity and/or customer may be informed via certain numbers, charts, plots, or the like whether and/or to what extent the primary entity is saving the customer money. For example, an output module 106 may generate a graph plotting monetary expenditures (e.g., total expenditures) versus time for each entity (e.g., retail store) at issue. Thus, each entity may correspond to a different line and the spacing between the lines for any given date may represent the difference in the running total between the corresponding entities. In selected embodiments, such data may be presented to the customer in real time, on demand, or periodically and not merely at the end of the time period 88 corresponding to the guarantee 76.

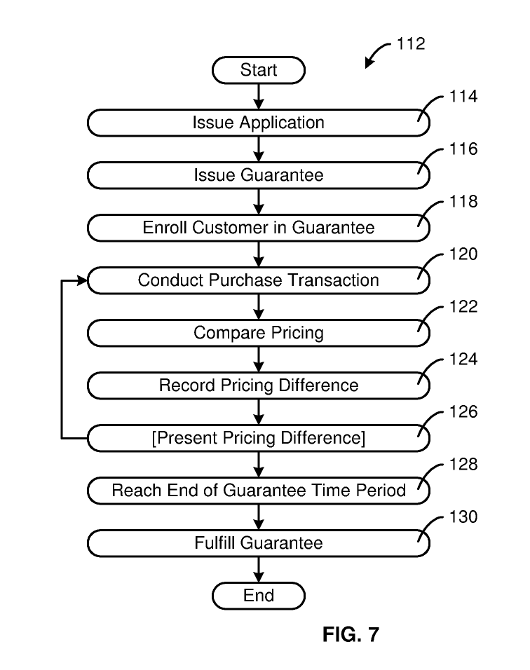

Referring to FIG. 7, one method 112 in accordance with the present invention may begin when an application is issued 114 and/or installed on a computing device of a customer. In selected embodiments, the application may be programmed to receive, format, display, categorize, and/or analyze receipt data 45. Alternatively, or in addition thereto, the application may be programmed to enable a customer to participate in one or more promotional programs 74.

Within the method 112, an entity (e.g., a primary entity) may issue 116 a guarantee 76 and enroll 118 one or more customers therein. The entity may then conduct 120 a purchase transaction with the enrolled customers. For example, a customer may enter a “brick-and-mortar” business location (e.g., a brick-and-mortar retail store) and approach a POS system 10. At the POS system 10, a transaction (e.g., a purchase) may be initiated. As part of a transaction, a customer may be identified. For example, a POS system 10 may scan a membership card, club card, loyalty card, identification card, credit card, debit card, fingerprint, or the like. From the scan, identification information (e.g., a unique identification, card, or membership number) may be obtained. Alternatively, while a cashier is processing a transaction, a customer may be prompted via a card reader 18b, customer-facing display 20a, or the like to enter (e.g., type in using the card reader 18b) an identification number (e.g., a mobile telephone number).

Identification information may be passed from a POS system 10 to one or more other computers (e.g., servers 26, 34) within a computer system. The identification information may link a customer and a corresponding transaction to one or more records stored within a computer system. In selected embodiments, such records may contain the information necessary to identify and communicate with a computing device of the corresponding customer.

After a transaction has been initiated, one or more items may be identified by a POS system 10. In selected embodiments, bar codes (e.g., UPCs) of one or more items may be scanned by a scanner 16a of a POS system 10. Accordingly, the prices being charged for certain items may be read and recorded. For example, receipt data 45 identifying the items forming part of the transaction may be passed from a POS system 10 to one or more other computers (e.g., servers 26, 34 or the like executing all or some portion of a guarantee module 94) within a computer system.

Using competitor pricing data 110, a comparison may be made 122 between the amount charged by a primary entity and one or more hypothetical amounts that would have been charged by one or more competitors of the primary entity. This difference in pricing may me recorded 124 and, in selected embodiments, presented 126 to the corresponding customer. Such steps 120, 122, 124, 126 may be repeated each time an enrolled customer shops the primary entity.

Eventually, an end of a time period 88 associated with a guarantee 76 may be reached 128. Accordingly, the guarantee 76 may be fulfilled 130. That is, if the total amount charged by the primary entity satisfies the guarantee 76 (e.g., is less than the amount that would have been charged by any competitor), then nothing is owed to the corresponding customer. Conversely, if the total amount charged by the primary entity does not satisfy the guarantee 76 (e.g., is not less than the amount that would have been charged by a competitor), then compensation 90 in accordance with the details 80 of the guarantee 76 may be made.

Such compensation 90 may take various forms. In selected embodiments, compensation 90 may comprise a refund or rebate of some amount or percentage (e.g., a percentage of a total amount spent by the customer at the primary entity on products relevant to the guarantee 76), a refund or rebate matching the difference between the amount charged and the amount that would have been charged by the least expensive competitor, a refund or rebate besting, by some amount, the difference between the amount charged and the amount that would have been charged by the least expensive competitor, or the like.

The flow chart in FIG. 7 illustrates the functionality and operation of one possible implementation of a system, method, and computer program product according to certain embodiments of the present invention. In this regard, each block in the flowchart may represent a module, segment, or portion of code, which comprises one or more executable instructions for implementing the specified logical function(s). It will also be noted that each block of the flowchart illustration may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for comparing pricing of selected products over a certain period of time, the method comprising:
completing, by a computer system, a plurality of transactions between a first business and a particular customer, the plurality of transactions comprising the purchase, by the particular customer, of a plurality of goods from the first business;
recording, by the computer system, an actual cost charged the particular customer for the plurality of goods;
calculating, by the computer system, a first hypothetical cost reflecting what the particular customer would have been charged for the plurality of goods had the plurality of goods been purchased from a second business;
generating, by the computer system, a first comparison between the actual cost and the first hypothetical cost; and
presenting, by the computer system, the first comparison to the particular customer.

2. The method of claim 1, where the completing comprises completing a last transaction of the plurality of transactions at least one month after completing a first transaction of the plurality of transactions.

3. The method of claim 1, further comprising enrolling, by the computer system, the particular customer in a guarantee program promising the particular customer a specified monetary return if the actual cost is greater than the first hypothetical cost.

4. The method of claim 3, wherein the guarantee program comprises a specified term.

5. The method of claim 4, wherein the completing comprises completing the plurality of transactions within the specified term.

6. The method of claim 1, wherein the calculating further comprises calculating the first hypothetical cost to reflect what the particular customer would have been charged for each good of the plurality of goods had the each good been purchased from the second business at the time is was purchased from the first business.

7. The method of claim 1, further comprising:
calculating, by the computer system, a second hypothetical cost reflecting what the particular customer would have been charged for the plurality of goods had the plurality of goods been purchased from a third business;
generating, by the computer system, a second comparison between the actual cost and the second hypothetical cost; and
presenting, by the computer system, the second comparison to the particular customer.

8. The method of claim 7, further comprising enrolling, by the computer system, the particular customer in a guarantee program promising the particular customer a specified monetary return if the actual cost is greater than the first hypothetical cost or if the actual cost is greater than the second hypothetical cost.

9. The method of claim 1, wherein the completing comprises sending, to a computing device possessed by the particular customer, a plurality of electronic receipts, each electronic receipt of the plurality of electronic receipts documenting a different transaction of the plurality of transactions.

10. The method of claim 9, wherein the presenting comprises sending, by the computer system, data corresponding to the comparison to the computing device.

11. The method of claim 10, wherein the computing device comprises a mobile telephone.

12. A method for comparing pricing of selected products, the method comprising:
enrolling, by a computer system, a customer in a guarantee program promising the customer a specified monetary return if a first monetary amount is greater than any of one or more second monetary amounts;
completing, by a computer system, a plurality of transactions between a first store and the customer, the plurality of transactions comprising the purchase, by the customer, of a plurality of goods from the first store;
recording, by the computer system, the first monetary amount as an actual cost charged the customer for the plurality of goods;
calculating, by the computer system, the one or more second monetary amounts as one or more hypothetical costs reflecting what the customer would have been charged for the plurality of goods had the plurality of goods been purchased from one or more competing stores, respectively;
generating, by the computer system, a comparison between the actual cost and the one or more hypothetical costs; and
presenting, by the computer system, the comparison to the customer.

13. The method of claim 12, where the completing comprises completing a last transaction of the plurality of transactions at least one month after completing a first transaction of the plurality of transactions.

14. The method of claim 13, wherein the guarantee program comprises a specified term.

15. The method of claim 14, wherein the completing comprises completing the plurality of transactions within the specified term.

16. The method of claim 12, wherein the completing comprises sending, to a computing device possessed by the customer, a plurality of electronic receipts, each electronic receipt of the plurality of electronic receipts documenting a different transaction of the plurality of transactions.

17. The method of claim 16, wherein the presenting comprises sending, by the computer system, data corresponding to the comparison to the computing device.

18. The method of claim 17, wherein the computing device comprises a mobile telephone.

19. The method of claim 12, wherein the one or more competing stores are located within 15 miles of the first store.

20. A computer system comprising:
one or more processors;
one or more memory devices operably connected to the one or more processors; and
the one or more memory devices collectively storing
a data store storing an actual cost charged a particular customer for a plurality of goods purchased by the particular customer from a first store over multiple days,
a pricing module programmed to access pricing data identifying the cost charged by one or more competing stores for the plurality of goods,
the pricing module further programmed to use the pricing data to calculate one or more hypothetical costs reflecting what the particular customer would have been charged for the plurality of goods had the plurality of goods been purchased from one or more competing stores, respectively,
a comparison module programmed to generate a comparison between the actual cost and the one or more hypothetical costs, and
an output module programmed to present the comparison to the particular customer.
